(19) United States
(12) Patent Application Publication
(10) Pub. No.: US 2014/0046933 A1
(43) Pub. Date: Feb. 13, 2014

(54) METHOD AND SYSTEM FOR DISPLAYING USER ACTIVITIES BASED ON GEOGRAPHIC LOCATION INFORMATION AND COMPUTER STORAGE MEDIUM

(71) Applicants: Desheng LIU, Guangdong (CN); Qiang Lin, Guangdong (CN)

(72) Inventors: Desheng LIU, Guangdong (CN); Qiang Lin, Guangdong (CN)

(73) Assignee: TENCENT TECHNOLOGY (SHENZHEN) COMPANY LIMITED

(21) Appl. No.: 14/057,985

(22) Filed: Oct. 18, 2013

Related U.S. Application Data
(63) Continuation of application No. PCT/CN2012/070916, filed on Feb. 7, 2012.

(30) Foreign Application Priority Data
Apr. 22, 2011 (CN) 201110101858.3

(51) Int. Cl. G06F 17/30

(52) U.S. Cl. CPC G06F 17/30554
USPC 707/722

(57) ABSTRACT

The present invention relates to method and system for displaying user activities based on geographical location information, and a computer storage medium, the method comprising: an SNS server obtaining personal activities information submitted by a first SNS user and the geographical location information of the first SNS user submitting the personal activities information; establishing a personal activities information database of the first SNS user according to the personal activities information, the geographical location information and the identification number of the first SNS user, and storing the database in the SNS server; the SNS server searching for the friend list of the first SNS user in the database, notifying a second SNS user on the friend list of the first SNS user of the personal activities information, the geographical location information and the identification number of the first SNS user and displaying in the friend status of the second SNS user.

### RELATED APPLICATIONS

This application is a continuation of U.S. International PCT Application No. PCT/CN2012/070916 filed Feb. 2, 2012 and Chinese Application No. 201110101858.3 filed Apr. 22, 2011. The foregoing applications are incorporated by reference herein in their entirety.

### TECHNICAL FIELD

The present disclosure relates to Internet application technology, and more particularly, to a method and system for displaying user activities based on geographic location information, as well as a computer storage medium therefor.

### BACKGROUND

Along with development of the network technology, Internet applications are getting more popular; and users often publish information in SNS community network through a mobile communication terminal, and share the information with friends in the community. Herein, the SNS (Social Networking Service(s)) is an Internet application service for helping people build social networks.

After a user has published a piece of information in the SNS community network, his/her friends usually cannot see where the information was published, which results in inconvenience to them.

### SUMMARY

In this case, there is a need to provide a method for displaying user activities based on geographic location information, to facilitate users in checking personal activities of their friends at different locations.

There is provided a method for displaying user activities based on geographic location information, comprising steps of:

obtaining, by a SNS server, personal activity information submitted by a first SNS user and geographic location information of the first SNS user who submits the personal activity information;

establishing a personal activity information database of the first SNS user based on the personal activity information, the geographic location information and a first SNS user identification number, and storing the database in the SNS server; and

searching, by the SNS server, the database for a friend list of the first SNS user, notifying the personal activity information, the geographic location information and the first SNS user identification number of the first SNS user to a second SNS user on the friend list of the first SNS user, and displaying them in a friend activity of the second SNS user.

Preferably, the method may further include steps of:

obtaining, by the SNS server, geographic location information of the displayed friend activity, which information is selected by the second SNS user; and

screening the friend activity of the second SNS user, based on the geographic location information, for respective friends' personal activity information corresponding to the geographic location information, and listing and displaying user identification numbers of the respective friends of the second SNS user and personal activity information thereof in accordance with the geographic location information.

Preferably, the step of obtaining, by a SNS server, geographic location information of the first SNS user who submits the personal activity information may include: obtaining geographic coordinate information of a mobile communication terminal through which the personal activity information is submitted; and obtaining the geographic location information of the first SNS user who submits the personal activity information based on the geographic coordinate information and a geographic information system.

Preferably, the step of obtaining the geographic location information of the first SNS user who submits the personal activity information based on the geographic coordinate information and a geographic information system may include: matching the geographic coordinate information of the mobile communication terminal with geographic coordinates stored in the geographic information system, to obtain a geographic location corresponding to the geographic coordinate information of the mobile communication terminal.

Preferably, the method may further include steps of: setting a link address of the personal activity information of the first SNS user; and displaying the link address in the friend activity of the second SNS user.

In addition, there is also a need to provide a system for displaying user activities based on geographic location information, to facilitate a user in checking personal activities of friends at different locations.

There is provided a system for displaying user activities based on geographic location information, comprising:

an information obtaining module configured to obtain personal activity information submitted by a first SNS user and geographic location information of the first SNS user who submits the personal activity information;

an establishing module configured to establish a personal activity information database of the first SNS user based on the personal activity information, geographic location information and a first SNS user identification number;

a notifying module configured to search the database for a friend list of the first SNS user, and notify the personal activity information, the geographic location information and the first SNS user identification number of the first SNS user to a second SNS user on the friend list of the first SNS user; and

a displaying module configured to display the personal activity information, the geographic location information and the first SNS user identification number of the first SNS user in a friend activity of the second SNS user.

Preferably, the system may further include a searching module configured to obtain geographic location information of the displayed friend activity, which information is selected by the second SNS user; and a screening module configured to screen the friend activity of the second SNS user for respective friends' personal activity information corresponding to the geographic location information; and the displaying module may be further configured to list and display user identification numbers of the respective friends of the second SNS user and personal activity information thereof in accordance with the geographic location information.

Preferably, the information obtaining module may be further configured to obtain geographic coordinate information of a mobile communication terminal through which the personal activity information is submitted, to obtain the geographic location information of the first SNS user who submits the personal activity information based on the geographic coordinate information and a geographic information system.

Preferably, the information obtaining module may be further configured to match the geographic coordinate information of the mobile communication terminal with geographic coordinates stored in the geographic information system, to obtain a geographic location corresponding to the geographic coordinate information of the mobile communication terminal.

Preferably, the system may further include a setting module connected to the displaying module, configured to set a link address of the personal activity information of the first SNS user; and the displaying module may be further configured to display the link address in the friend activity of the second SNS user.

Furthermore, there is still a need to provide a computer storage medium to facilitate a user in checking personal activities of friends at different locations.

There is provided a computer storage medium containing computer executable instructions for executing a method for displaying user activities based on geographic location information, the method comprising steps of:

obtaining, by a SNS server, personal activity information submitted by a first SNS user and geographic location information of the first SNS user who submits the personal activity information;

establishing a personal activity information database of the first SNS user based on the personal activity information, the geographic location information and a first SNS user identification number, and storing the database in the SNS server; and

searching, by the SNS server, the database for a friend list of the first SNS user, notifying the personal activity information, the geographic location information and the first SNS user identification number of the first SNS user to a second SNS user on the friend list of the first SNS user, and displaying them in a friend activity of the second SNS user.

In the above-mentioned method and system for displaying user activities based on geographic location information, as well as a computer storage medium therefor, upon obtaining the personal activity information submitted by the first SNS user, the geographic location information of the first SNS user who submits the personal activity information is obtained at the same time, and the personal activity information, the geographic location information and the first SNS user identification number of the first SNS user are displayed in the friend activity of the second SNS user, in order for the second SNS user to check personal activities of friends at different locations.

### BRIEF DESCRIPTION OF THE DRAWINGS

FIG. 1 is a flow chart of a method for displaying user activities based on geographic location information in one embodiment;

FIG. 2 is a flow chart of a method for obtaining the geographic location information of the user who submits the information as shown in FIG. 1;

FIG. 3 is a schematic diagram of the internal structure of a system for displaying user activities based on geographic location information in one embodiment; and

FIG. 4 is a schematic diagram of the internal structure of a system for displaying user activities based on geographic location information in another embodiment.

### DETAILED DESCRIPTION

Detailed description would be made hereinafter in conjunction with the specific embodiments and accompanying drawings.

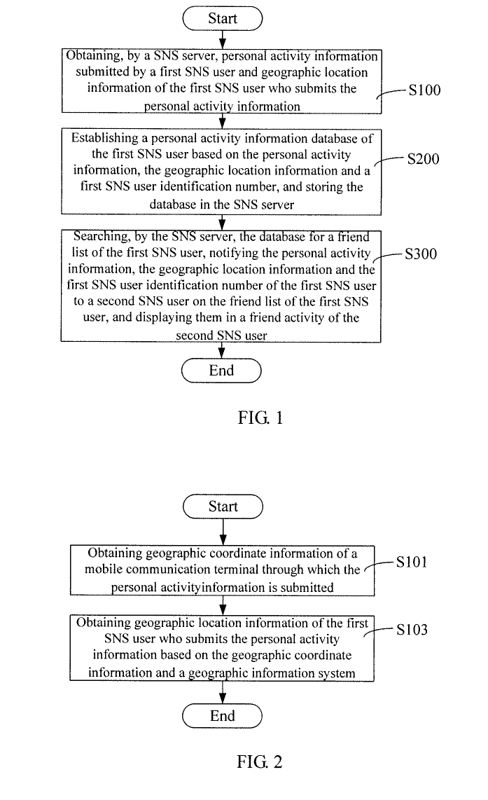

As shown in FIG. 1, in one embodiment, a method for displaying user activities based on geographic location information, comprises:

step S100: obtaining, by a SNS server, personal activity information submitted by a first SNS user and geographic location information of the first SNS user who submits the personal activity information.

When the first SNS (Social Networking Services) user submits the personal activity information to the SNS server through a mobile communication terminal, the geographic location information of the mobile communication terminal may be also submitted at the same time, that is, the geographic location information of the first SNS user who submits the personal activity information, for example, personal activity information for Universiade Outlook which the first SNS user submitted at Shenzhen through a mobile communication terminal (e.g., a mobile phone). The personal activity information may refer to information published by a user, including but not limited to blogs, micro-blogs, uploaded pictures, comment contents, reply contents, shared contents, participated voting, played games, or updates of the SNS user's personal profile published by a SNS user. The updates of the SNS user's personal profile may include a change of a user nickname, or a replacement of a user icon, etc.

In one embodiment, as shown in FIG. 2, the step of obtaining, by a SNS server, the personal activity information submitted by a first SNS user and the geographic location information of the first SNS user who submits the personal activity information may include:

step S101: obtaining geographic coordinate information of a mobile communication terminal, through which the personal activity information is submitted.

With external positioning mechanisms, such as GPS (Global Positioning System), or through radio communications networks of the telecommunication or mobile operators, such as GSM (Global System for Mobile Communications) network, and CDMA (Code Division Multiple Access) network, the geographic coordinate information of the mobile communication terminal is obtained.

In step S103, the geographic location information of the first SNS user who submits the personal activity information based on the geographic coordinate information and a geographic information system is obtained.

After the geographic coordinate information of the mobile communication terminal is obtained, in combination with GIS (Geographic Information System), a geographic location of the mobile communication terminal, i.e., the geographic location information of the first SNS user who submits the personal activity information, can be determined. The GIS system stores a corresponding relationship between the geographic coordinate information and the geographic location information. The specific step of determining the geographic location information of the mobile communication terminal may include: matching the geographic coordinate information of the mobile communication terminal with geographic coordinates stored in the geographic information system, to obtain a geographic location corresponding to the geographic coordinate information of the mobile communication terminal. For example, if the obtained geographic coordinate information of the mobile communication terminal is “north latitude 39.9°, east longitude 116.3°”, after searching for a match in the GIS system according to the latitude and the longitude, it can be determined that the geographic location is “Beijing District”.

In step S200, a personal activity information database of the first SNS user based on the personal activity information, the geographic location information and a first SNS user identification number is established, and stored in the SNS server.

After the SNS server obtains the personal activity information submitted by the first SNS user through the mobile communication terminal and the geographic location information, it is necessary to establish a corresponding relationship among the personal activity information of the first SNS user, the geographic location information of the first SNS user who submits the personal activity information and the first SNS user identification number (shortly referred to as ID), that is, to establish a personal activity information database of the first SNS user, and store the database in the SNS server, facilitating the searching. As shown in Table 1, in the personal activity information database of a SNS user A, the SNS user A submits personal activity information 1 at a geographic location a, personal activity information 2 at a geographic location b, and personal activity information 3 at a geographic location c. In particular, for example, if the SNS user A's ID is 12345, the submitted personal activity information is “watching the Asian Games”, and the geographic location information is “Guangzhou”, then the personal activity information database of the SNS user A records a piece of data of “the SNS user A submitted ‘watching the Asian Games’ at Guangzhou”.

TABLE 1

| | | |
|---|---|---|
| SNS User A's ID | Personal Activity Information 1 | Geographic |
| | | Location a |
| SNS User A's ID | Personal Activity Information 2 | Geographic |
| | | Location b |
| SNS User A's ID | Personal Activity Information 3 | Geographic |
| | | Location c |

In addition, upon the SNS user A submits the new personal activity information n at the geographic location c, the SNS user A′ ID, the personal activity information n and the geographic location c are updated into the personal activity information database of the SNS user A, as shown in FIG. 2.

TABLE 2

| | | |
|---|---|---|
| SNS User A' ID | Personal activity Information 1 | Geographic |
| | | Location a |
| SNS User A' ID | Personal activity Information 2 | Geographic |
| | | Location b |
| SNS User A' ID | Personal activity Information 3 | Geographic |
| | | Location c |
| SNS User A' ID | Personal activity Information n | Geographic |
| | | Location c |

In step S300, the database is searched for a friend list of the first SNS user by the SNS server, and the first SNS user's personal activity information, the geographic location information and the first SNS user identification number are notified to a second SNS user on the friend list of the first SNS user, and displayed in a friend activity of the second SNS user.

The database may store friend lists of respective SNS users. The SNS server searches the database for a friend list of a first SNS user, the friend list of the first SNS user has at least one friend, who is the second SNS user, and notifies, to the second SNS user, the first SNS user ID, the submitted personal activity information and the geographic location information of the first SNS user who submits the personal activity information, and displays them in a friend activity of the second SNS user, for the second SNS user to check. If the friend list of the SNS user A in the database in the SNS server contains a SNS user B and a SNS user X, and Xiangshan travel notes submitted by the SNS user A at Beijing, including specifically the personal activity information submitted by the SNS user A as the detailed contents of the travel notes, the geographic location as Beijing, and the SNS user A's ID as “1234”, are be displayed in friend activities of the SNS user B and the SNS user X who are both friends of the SNS user A.

In one embodiment, the above method for displaying user activities based on geographic location information may further include: setting a link address of the personal activity information of the first SNS user; and displaying the link address in the friend activity of the second SNS user. The personal activity information submitted the SNS user A can be a title and a link address in the friend activities of the SNS user B and the SNS user X, and if it is determined that the SNS user B and the SNS user X trigger the address, the detailed content of the personal activity information is pulled from the personal activity information database of the SNS user A in the SNS server to be checked.

Table 3 is detailed records of friend activity of the SNS user X who is a friend of the SNS user A.

TABLE 3

| | | |
|---|---|---|
| SNS User E | Personal Activity Information 1 | Geographic Location x |
| SNS User B | Personal Activity Information 2 | Geographic Location b |
| SNS User N | Personal Activity Information 3 | Geographic Location x |
| SNS User N | Personal Activity Information 4 | Geographic Location b |
| . . . | . . . | . . . |
| SNS User A | Personal Activity Information n | Geographic Location b |

In Table 3, the friends of the SNS user X include the SNS user A, the SNS user B, the SNS user E, and the SNS user N, etc. The SNS user E submits the personal activity information 1 at the geographic location x, the user B submits the information 2 at the geographic location b, the user N submits the information 4 at the geographic location b, and the user A submits the information n at the geographic location b.

In a preferred embodiment, the above method for displaying user activities based on geographic location information may further include: obtaining, by the SNS server, the geographic location information of the displayed friend activity, which is selected by the second SNS user; based on the geographic location information, screening the friend activity of the second SNS user for respective friends' personal activity information corresponding to the geographic location information; and listing and displaying user identification numbers of the respective friends of the second SNS user and the respective personal activity information thereof in accordance with the geographic location information.

After the second SNS user selects geographic location information from the friend activity, respective friends' personal activity information corresponding to the geographic location information can be picked up from the friend activity of the second SNS user. For example, in the above embodiment, if the second SNS user is the SNS user X, the ID of a friend, who submits the personal activity information at geographic location b, in the friend activity of the SNS user X, and the personal activity information thereof are shown in Table 4.

TABLE 4

| | | |
|---|---|---|
| SNS User B | Personal Activity Information 2 | Geographic Location b |
| SNS User N | Personal Activity Information 4 | Geographic Location b |
| SNS User A | Personal Activity Information n | Geographic Location b |

In Table 4, the SNS user X's friends who submit information at the geographic location b include the SNS user A, the SNS user B, and the SNS user N.

In addition, the first SNS user and the second SNS user are friends of each other, the personal activity information of the first SNS user would be displayed in the friend activity of the second SNS user, while the personal activity information of the second SNS user would also be displayed in the friend activity of the first SNS user. Therefore, the above-described operations on the first SNS user and the second SNS user are interchangeable.

Furthermore, the present disclosure further provides a computer storage medium containing computer executable instructions for executing a method for displaying user activities based on geographic location information, and the specific steps thereof are as described in the above method, which would not be redundantly described herein.

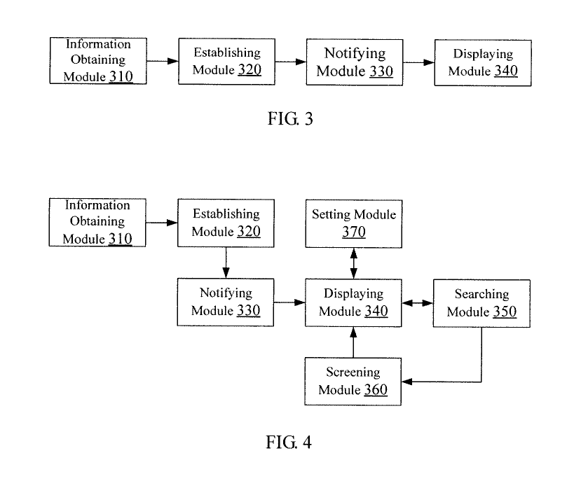

As shown in FIG. 3, in one embodiment, a system for displaying user activities based on geographic location information includes an information obtaining module 310, an establishing module 320, a notifying module 330 and a displaying module 340.

The information obtaining module 310 may be configured to obtain personal activity information submitted by a first SNS user and geographic location information of the first SNS user who submits the personal activity information. When the first SNS (Social Networking Services) user submits the personal activity information to the SNS server through a mobile communication terminal, he/she also submits the geographic location information of the mobile communication terminal at the same time, that is, submits the geographic location information of the first SNS user who submits the personal activity information. The information obtaining module 310 may obtain the personal activity information and the geographic location information of the first SNS user who submits the personal activity information, for example, personal activity information for Universiade Outlook which the first SNS user submitted at Shenzhen through a mobile communication terminal (e.g., a mobile phone). The personal activity information may refer to personal daily records published by a SNS user, uploaded pictures, or updates of the SNS user's personal profile, etc. The updates of the SNS user's personal profile may include a change of user nickname, or a replacement of user icon, etc.

The information obtaining module 310 may be further configured to obtain geographic coordinate information of a mobile communication terminal through which the personal activity information is submitted, to obtain the geographic location information of the first SNS user who submits the personal activity information based on the geographic coordinate information and a geographic information system. With external positioning methods, such as GPS (Global Positioning System), or through radio communications networks of the telecommunications and mobile operators, such as GSM (Global System for Mobile Communications) network, CDMA (Code Division Multiple Access) network, etc., the geographic coordinate information of the mobile communication terminal is obtained. After the information obtaining module 310 obtains the geographic coordinate information, in combination with GIS (Geographic Information System), a geographic location of the mobile communication terminal, i.e., the geographic location information of the first SNS user who submits the personal activity information, can be determined. The GIS system stores a corresponding relationship between the geographic coordinate information and the geographic location information. The information obtaining module 310 may match the geographic coordinate information of the mobile communication terminal with geographic coordinates stored in the geographic information system, to obtain a geographic location corresponding to the geographic coordinate information of the mobile communication terminal. For example, if the obtained geographic coordinate information of the mobile communication terminal is “north latitude 39.9°, east longitude 116.3°”, after searching for a match in the GIS according to the latitude and the longitude, it can be determined that the geographic location is “Beijing District”.

The establishing module 320 may be configured to establish a personal activity information database of the first SNS user based on the personal activity information, the geographic location information and a first SNS user ID. After the information obtaining module 310 obtains the personal activity information submitted by the first SNS user through the mobile communication terminal and the geographic location information, it is necessary that the establishing module 320 establish a corresponding relationship among the personal activity information of the first SNS user, the geographic location information of the first SNS user who submits the personal activity information and the first SNS user ID, that is, to establish a personal activity information database of the first SNS user, and store the database in the SNS server, facilitating the searching. As shown in Table 1, in the personal activity information database of the SNS user A, the SNS user A submits the personal activity information 1 at the geographic location a, the personal activity information 2 at the geographic location b, and the personal activity information 3 at the geographic location c. Specifically, for example, if the SNS user A's ID is 12345, the submitted personal activity information is “watching the Asian Games”, and the geographic location information is “Guangzhou”, the establishing module 320 may establish a personal activity information database of the SNS user A, and then the personal activity information database would record a piece of data of “the SNS user A submitted ‘watching the Asian Games’ at Guangzhou”. In addition, when the SNS user A submits new the personal activity information n at the geographic location c, the establishing module 320 may update the SNS user A's ID, the information n and the geographic location c and stores them in the personal activity information database of the SNS user A, as shown in FIG. 2.

The notifying module 330 may be configured to search the database for a friend list of the first SNS user, notify the personal activity information, the geographic location information and the first SNS user identification number of the first SNS user to a second SNS user on the friend list of the first SNS user. The database in the SNS server is searched for the friend list of the first SNS user, and the friend list of the first SNS user contains at least one friend, who is/are the second SNS user(s). The database stores friend lists for respective SNS users.

The displaying module 340 may be configured to display the personal activity information, the geographic location information and the first SNS user identification number of the first SNS user in a friend activity of the second SNS user, for the second SNS user to check. If the friend list of the SNS user A in the database in the SNS server contains a SNS user B and a SNS user X, and Xiangshan travel notes submitted by the SNS user A at Beijing, including specifically the personal activity information submitted by the SNS user A as the detailed content of the travel notes, the geographic location as Beijing, and the SNS user A's ID as “1234”, would be displayed in friend activities of the SNS user B and the SNS user X who are both friends of the SNS user A. Table 3 is a detailed record of the friend activity of the SNS user X who is a friend of the SNS user A. In the Table 3, the friends of the SNS user X include the SNS user A, the SNS user B, a SNS user E, and a SNS user N, etc. The SNS user E submits personal activity information 1 at a geographic location x, the user B submits an information 2 at a geographic location b, the user N submits an information 4 at a geographic location b, and the user A submits an information n at a geographic location b. Moreover, the information obtaining module 310, the establishing module 320 and the notifying module 330 are modules running on the SNS server, and the displaying module 340 is a module running on the terminal.

In one embodiment, as shown in FIG. 4, in addition to the information obtaining module 310, the establishing module 320, the notifying module 330 and the displaying module 340, the system for displaying user activities based on geographic location information may further include a searching module 350, a screening module 360 and a setting module 370.

The searching module 350 may be configured to obtain geographic location information of the displayed friend activity, which information is selected by the second SNS user. The screening module 360 may be configured to screen the friend activity of the second SNS user for respective friends' personal activity information corresponding to the geographic location information. The displaying module 340 may be further configured to list and display user identification numbers of the respective friends of the second SNS user and the personal activity information thereof in accordance with the geographic location information. After the searching module 350 obtains the geographic location information selected by the second SNS user from the friend activity, the screening module 360 picks up respective friends' personal activity information corresponding to the geographic location information from the friend activity of the second SNS user. If the second SNS user is the SNS user X, the IDs of the friends, who submit the personal activity information at geographic location b, of the friends of the SNS user X, and the personal activity information thereof, are shown in Table 4, and the SNS user X's friends who submit information at the geographic location b are the SNS user A, the SNS user B, and the SNS user N.

In addition, the first SNS user and the second SNS user are friends of each other, the personal activity information of the first SNS user would be displayed in the friend activity of the second SNS user, while the personal activity information of the second SNS user would also be displayed in the friend activity of the first SNS user. Therefore, the above-described operations on the first SNS user and the second SNS user are interchangeable. The searching module 350 may also obtain the geographic location information selected by the first SNS user, the screening module 360 screens the friend activity of the first SNS user for respective friends' personal activity information corresponding to the geographic location information in accordance with the geographic location information, and the displaying module 340 may be further configured to list and display the user IDs of the friends of the first SNS user and the personal activity information thereof according to the geographic location information.

The setting module 370 may be configured to set a link address of the personal activity information of the first SNS user; the displaying module 340 is further configured to display the link address in the friend activity of the second SNS user. The setting module 370 may set a link address of the personal activity information submitted by the SNS user A, and the link address is displayed by the displaying module 340 in the friend activity of the SNS user B and the friend activity of the SNS user X. After the searching module 350 determines that the SNS user B and the SNS user X trigger the link address, the displaying module 340 would extract the detailed content of the personal activity information from the personal activity information database of the SNS user A in the SNS server and check the content.

In the method and system for displaying user activities based on geographic location information, and the computer storage medium therefor, upon obtaining the personal activity information submitted by the first SNS user, the geographic location information of the first SNS user who submits the personal activity information is obtained at the same time, and the personal activity information, the geographic location information and the first SNS user identification number of the first SNS user are displayed in the friend activity of the second SNS user, for the second SNS user to check the personal activities of friends at different locations.

The above described embodiments are only several implementations of the present invention, although explained with specific details, they would not be construed as limiting the scope of the present invention. It should be noted that, for one person ordinarily skilled in the art, various variations and modifications may be made without departing from the inventive concept of the present invention, which all are within the scope of the present invention. Therefore, the protection scope of the present invention should be in accordance with the scope of the following claims.

What is claimed is:

1. A method for displaying user activities based on geographic location information, comprising steps of:
obtaining, by a SNS server, personal activity information submitted by a first SNS user and geographic location information of the first SNS user who submits the personal activity information;
establishing a personal activity information database of the first SNS user based on the personal activity information, the geographic location information and a first SNS user identification number, and storing the database in the SNS server; and
searching, by the SNS server, the database for a friend list of the first SNS user, notifying the personal activity information, the geographic location information and the first SNS user identification number of the first SNS user to a second SNS user on the friend list of the first SNS user, so that they can be displayed in a friend activity of the second SNS user.

2. The method for displaying user activities based on the geographic location information according to claim 1, further including steps of:
obtaining, by the SNS server, particular geographic location information of the displayed friend activity, which information is selected by the second SNS user; and
screening the friend activity of the second SNS user, based on the selected particular geographic location information, for respective friends' personal activity information corresponding to the selected particular geographic location information, so that user identification numbers of the respective friends of the second SNS user and personal activity information thereof can be listed and displayed in accordance with the selected particular geographic location information.

3. The method for displaying user activities based on geographic location information according to claim 2, wherein the selected particular geographic location information is irrelevant to the current geographic location information of the second SNS user.

4. The method for displaying user activities based on geographic location information according to claim 1, wherein the personal activity information includes at least one of: blogs, micro-blogs, uploaded pictures, comment contents, reply contents, shared contents, participated voting, played games, or updates of the SNS user's personal profile published by a SNS user, a change of a user nickname, and/or a replacement of a user icon.

5. The method for displaying user activities based on geographic location information according to claim 1, wherein the step of obtaining, by a SNS server, the geographic location information of the first SNS user who submits the personal activity information includes: obtaining geographic coordinate information of a mobile communication terminal through which the personal activity information is submitted; and obtaining the geographic location information of the first SNS user who submits the personal activity information based on the geographic coordinate information and a geographic information system.

6. The method for displaying user activities based on geographic location information according to claim 5, wherein the step of obtaining the geographic location information of the first SNS user who submits the personal activity information based on the geographic coordinate information and the geographic information system includes: matching the geographic coordinate information of the mobile communication terminal with geographic coordinates stored in the geographic information system, to obtain a geographic location corresponding to the geographic coordinate information of the mobile communication terminal.

7. The method for displaying user activities based on geographic location information according to claim 1, further including steps of: setting a link address of the personal activity information of the first SNS user so that the link address can be displayed in the friend activity of the second SNS user.

8. A system for displaying user activities based on geographic location information, comprising:
an information obtaining module configured to obtain personal activity information submitted by a first SNS user and geographic location information of the first SNS user who submits the personal activity information;
an establishing module configured to establish a personal activity information database of the first SNS user based on the personal activity information, geographic location information and a first SNS user identification number;
a notifying module configured to search the database for a friend list of the first SNS user, notify the personal activity information, the geographic location information and the first SNS user identification number of the first SNS user to a second SNS user on the friend list of the first SNS user, so that the personal activity information, the geographic location information and the first SNS user identification number of the first SNS user can be displayed in a friend activity of the second SNS user.

9. The system for displaying user activities based on geographic location information according to claim 8, further including: a searching module configured to obtain particular geographic location information of the displayed friend activity, which information is selected by the second SNS user; and a screening module configured to screen the friend activity of the second SNS user for respective friends' personal activity information corresponding to the selected particular geographic location information so that user identification numbers of the respective friends of the second SNS user and personal activity information thereof can be listed and displayed in accordance with the selected particular geographic location information.

10. The system for displaying user activities based on geographic location information according to claim 9, wherein the selected particular geographic location information is irrelevant to the current geographic location information of the second SNS user.

11. The system for displaying user activities based on geographic location information according to claim 8, wherein the personal activity information includes at least one of: blogs, micro-blogs, uploaded pictures, comment contents, reply contents, shared contents, participated voting, played games, or updates of the SNS user's personal profile published by a SNS user, a change of a user nickname, or a replacement of a user icon.

12. The system for displaying user activities based on geographic location information according to claim 8, wherein the information obtaining module is further configured to obtain geographic coordinate information of a mobile communication terminal through which the personal activity information is submitted, to obtain the geographic location information of the first SNS user who submits the personal activity information based on the geographic coordinate information and a geographic information system.

13. The system for displaying user activities based on geographic location information according to claim 12, wherein the information obtaining module is further configured to match the geographic coordinate information of the mobile communication terminal with geographic coordinates stored in the geographic information system, to obtain a geographic location corresponding to the geographic coordinate information of the mobile communication terminal.

14. The system for displaying user activities based on geographic location information according to claim 8, further including a setting module, configured to set a link address of the personal activity information of the first SNS user so that the link address can be displayed in the friend activity of the second SNS user.

15. A computer storage medium containing computer executable instructions for executing a method for displaying user activities based on geographic location information, the method comprising steps of:
obtaining, by a SNS server, personal activity information submitted by a first SNS user and geographic location information of the first SNS user who submits the personal activity information;
establishing a personal activity information database of the first SNS user based on the personal activity information, the geographic location information and a first SNS user identification number, and storing the database in the SNS server; and
searching, by the SNS server, the database for a friend list of the first SNS user, notifying the personal activity information, the geographic location information and the first SNS user identification number of the first SNS user to a second SNS user on the friend list of the first SNS user, so that they can be displayed in a friend activity of the second SNS user.

16. The computer storage medium according to claim 15, wherein the method for displaying user activities based on geographic location information further includes steps of:
obtaining, by the SNS server, particular geographic location information of the displayed friend activity, which information is selected by the second SNS user; and
screening the friend activity of the second SNS user, based on the selected particular geographic location information, for respective friends' personal activity information corresponding to the selected particular geographic location information, so that user identification numbers of the respective friends of the second SNS user and personal activity information thereof can be listed and displayed in accordance with the selected particular geographic location information.

17. The computer storage medium according to claim 16, wherein in the method for displaying user activities based on geographic location information, the selected particular geographic location information is irrelevant to the current geographic location information of the second SNS user.

18. The computer storage medium according to claim 15, wherein in the method for displaying user activities based on geographic location information, the step of obtaining, by a SNS server, personal activity information submitted by a first SNS user and geographic location information of the first SNS user who submits the personal activity information includes: obtaining geographic coordinate information of a mobile communication terminal through which the personal activity information is submitted; and obtaining the geographic location information of the first SNS user who submits the personal activity information based on the geographic coordinate information and a geographic information system.

19. The computer storage medium according to claim 18, wherein in the method for displaying user activities based on geographic location information, the step of obtaining the geographic location information of the first SNS user who submits the personal activity information based on the geographic coordinate information and a geographic information system includes: matching the geographic coordinate information of the mobile communication terminal with geographic coordinates stored in the geographic information system, to obtain a geographic location corresponding to the geographic coordinate information of the mobile communication terminal.

20. The computer storage medium according to claim 15, wherein the method for displaying user activities based on geographic location information further includes steps of: setting a link address of the personal activity information of the first SNS user so that the link address can be displayed in the friend activity of the second SNS user.
